(19) United States
(12) Patent Application Publication
(10) Pub. No.: US 2024/0092660 A1
(43) Pub. Date: Mar. 21, 2024

(54) WATER TREATMENT

(71) Applicant: Purolite Corporation, King of Prussia, PA (US)

(72) Inventor: Francis Boodoo, King of Prussia, PA (US)

(21) Appl. No.: 18/038,842

(22) PCT Filed: Nov. 23, 2021
(86) PCT No.: PCT/US2021/060517

§ 371 Date: May 25, 2023

Related U.S. Application Data
(60) Provisional application No. 63/118,279, filed on Nov. 25, 2020.

(51) Int. Cl. C02F 1/42

(52) U.S. Cl. CPC C02F 1/42; C02F 2001/422; C02F 2101/163

(57) ABSTRACT

Disclosed is a method for controlling the amount of leakage of per- and polyfluoroalkyl substances (PFAS) or other contaminants from resin beds during water purification processes that employ multiple vessels or banks of PFAS ad/ab-sorbing material such as ion exchange resins. The method comprises: providing at least two vessels (or at least two banks of vessels), each vessel containing a resin bed; and simultaneously passing the water source through the vessels in parallel. At start up and for a pre-determined period of time, the specific flow rates for passing the water source through the resin beds in the vessels (or banks of vessels) differ by at least 5%, preferably by at least 10%, more preferably at least 15%, and/or the volumes of resin beds in the vessels differ by at least 5%, preferably at least 10%, more preferably at least 15%.

### FIELD OF THE INVENTION

The present invention is directed to water treatment. More particularly, the present invention is directed to a method for controlling the amount of leakage of per- and polyfluoroalkyl substances (PFAS) or other contaminants from resin beds during water purification processes that employ multiple vessels or banks of vessels including PFAS-ad/ab-sorbing materials such as ion exchange resins.

### BACKGROUND OF THE INVENTION

Emerging health issues from the consumption of drinking water containing contaminants such as, for example, perfluoroalkyl and polyfluoroalkyl substances (PFAS), is now a global priority. PFAS encompass more than 4000 chemicals, and of these, about twelve are commonly found in drinking water supplies, including perfluorooctanoic acid (PFOA), perfluorooctanesulfonic acid (PFOS), and perfluorononanoic acid (PFNA). Typical concentrations can range from 20 to 2000 nanograms per liter (same as parts per trillion, or ppt). There are no universal guidelines or regulations for PFAS reduction in drinking water, but the U.S. Environmental Protection Agency (US EPA), individual states, and countries have set specific requirements which are generally maximum concentrations of up to 10 or 20 ppt.

Ion exchange resins displaying extremely high selectivity and operating capacity for removal of PFAS from water have been recently commercialized. PFAS-selective resins are preferably strong base anion exchange resins (gel or microporous type), preferably styrene-divinylbenzene gel resins in the chloride form, such as Purolite's Purofine® PFA694E, Dow's DOWEX™ PSR2 Plus, Calgon's CalRes 2301, ECT2's Sorbix LC1, or ResinTech's SIR-110-HP. Purofine® PFA694E can reduce commonly-found PFAS in treated water to non-detectable levels, such as, for example, less than 1 ppt. One liter of such resins can typically treat 200,000 to 600,000 liters (or bed volumes) of water before the resin must be replaced (typically every 12 to 48 months), making it simple and economical to use, and a more cost-effective alternative to granular activated carbon and reverse osmosis membrane systems. These ‘single-use’ PFAS-selective resins are preferred as they are simple to operate and require minimal operator attention. PFAS ad/ab-sorbing materials, such as modified clays and granular activated carbon, are also available for use in water purification processes.

Ion exchange water treatment plants for removal of PFAS from drinking water typically remove PFAS from the water by passing the water through two ion exchange vessels operated in series, known as a ‘LEAD-LAG’ pair of vessels. Such plants are used not only for PFAS removal, but for trace levels of other contaminants like perchlorate and chromate. The first vessel (the LEAD) removes the bulk of the targeted contaminant, while the LAG vessel polishes the output from the LEAD. The two vessels, operating jointly, provide greater removal efficiency and safety versus the use of a single LEAD vessel.

Plants treating large volumes of water using the ‘LEAD-LAG’ design can cost tens of millions of dollars to construct and operate. For example, capital expenditures for a 200 MGD (millions of gallons per day) plant requiring more than 100 to 200 12-foot diameter vessels can exceed 30 million dollars. Power and maintenance costs can add an extra 40 million dollars over a 20-year life. Therefore, any improvements for reducing plant size and operating costs are highly desirable.

U.S. Pat. No. 7,309,436 to Jensen, hereby incorporated by reference, discloses a system for removing perchlorate from water using a computer to control a large number of small resin beds operating in parallel to one another. The system includes periodic removal from service of a subset of the resin beds, so that exhausted resin can be replaced with fresh resin. U.S. Pat. No. 7,309,436 discloses staggered vessel operation, in which initially one or more resin beds are deliberately placed on standby and only a portion of the water is treated by the resin beds that are in service.

### SUMMARY OF THE INVENTION

In accordance with the present invention, there is provided a method for controlling the amount of leakage of per- and polyfluoroalkyl substances (PFAS) or other contaminants from resin beds during a water purification process to no more than a pre-determined amount, comprising the steps of:
a. providing at least two vessels (or at least two banks of vessels) for water purification, including a first vessel (or first bank of vessels) and a second vessel (or second bank of vessels); each vessel including a resin bed; and
b. starting the water purification process by passing a water source simultaneously and in parallel through the at least two vessels (or the at least two banks of vessels);
   characterized in that for a pre-determined period of time, the specific flow rates for passing the water source through the resin beds of the at least two vessels (or the at least two banks of vessels) differ by at least 5%, preferably by at least 10%, more preferably at least 15%; and/or for a pre-determined period of time, the volumes of the resin beds in the at least two vessels (or the at least two banks of vessels) differ by at least 5%, preferably at least 10%, more preferably at least 15%; and
   wherein the amount of leakage of per- and polyfluoroalkyl substances (PFAS) or other contaminants is the combined weighted average of leakage from the resin beds in the at least two vessels (or the at least two banks of vessels).

In a particularly preferred embodiment, the method comprises the steps of:
a. providing at least three vessels (or at least three banks of vessels) for water purification, including in any order: a first vessel (or first bank of vessels), a second vessel (or second bank of vessels), and a third vessel (or third bank of vessels); each vessel including a resin bed; and
b. starting the water purification process by passing a water source simultaneously and in parallel through the at least three vessels (or at least three banks of vessels);
   characterized in that for a pre-determined period of time, the specific flow rates for passing the water source through the resin beds in the at least three vessels (or the at least three banks of vessels) differ by at least 5%, preferably by at least 10%, more preferably at least 15%; and/or for a pre-determined period of time, the volumes of the resin beds in the at least three vessels (or the at least three banks of vessels) differ by at least 5%, preferably at least 10%, more preferably at least 15%;
   wherein the amount of leakage of per- and polyfluoroalkyl substances (PFAS) or other contaminants is the combined weighted average of leakage from the resin beds in the at least three vessels (or the at least three banks of vessels).

The resin bed may be any ad/ab-sorbing material suitable for use in a water purification process. The resin bed is preferably an ion exchange resin bed.

By ‘specific flow rate’ we mean the ratio of a volume of water flowing through a specified volume of resin bed over a given time period. Specific flow rates are preferably expressed in bed volumes per hour (BV/h). The volume of the resin bed is used as a reference equal to one bed volume, so that ‘bed volumes per hour’ refers to the volumes of water that are passed through one volume of resin bed in one hour. For example, ‘8 BV/h’ means that 8 volumes of water pass through one volume of resin bed in a vessel per hour.

By ‘leakage’ is meant the concentration level of per- and polyfluoroalkyl substances (PFAS) or other contaminants that pass through the resin beds during the water purification process, as opposed to being ad/ab-sorbed by (or retained in) the resin beds.

The amount of leakage of per- and polyfluoroalkyl substances (PFAS) or other contaminants from the at least two vessels (or the at least two banks of vessels) during the water purification process is the combined weighted average leakage from the resin beds in the at least two vessels (or the at least two banks of vessels).

The at least two vessels (or at least two bank of vessels) are preferably of a similar size or volume. The size or volume of the at least two vessels (or at least two bank of vessels) preferably differ by no more than 10%, preferably by no more than 5%. The size or volume of the at least two vessels (or at least two banks of vessels) are preferably substantially the same.

In the present invention, the at least two vessels (or the at least two banks of vessels) begin removing per- and polyfluoroalkyl substances (PFAS) or other contaminants from a water source at the same time, which means that none of the vessels needs to be placed on standby at the start of the water purification process and the total water demand can be treated.

The pre-determined period of time preferably runs until at least the resin bed in the first vessel (or first bank of vessels) has been replaced with a fresh resin bed. Preferably, the pre-determined period of time runs until all of the resin beds have been replaced with fresh resin beds at least once. A resin bed needs to be replaced or regenerated once leakage has reached an unacceptable or predetermined level.

The flow rate of the water source through the resin bed in the second vessel is preferably at least 20%, preferably at least 30%, preferably at least 40%, preferably at least 50%, preferably at least 60%, preferably at least 70%, preferably at least 80%, preferably at least 90%, and most preferably at least 100%, faster than the flow rate of the water source through the resin bed in the first vessel.

In a preferred embodiment, the flow rate of the water source through the resin bed in the second vessel is preferably about twice as fast as the flow rate of the water source through the resin bed in the first vessel.

In the preferred embodiment of at least three vessels (or at least three banks of vessels), the flow rate of the water source through the resin bed in the second vessel is preferably at least 20%, preferably at least 30%, preferably at least 40%, preferably at least 50%, preferably at least 60%, preferably at least 70%, preferably at least 80%, preferably at least 90%, and most preferably at least 100%, faster than the flow rate of the water source through the resin bed in the first vessel, and the flow rate of the water source through the resin bed in the third vessel is at least 20%, preferably at least 30%, preferably at least 40%, preferably at least 50%, preferably at least 60%, preferably at least 70%, preferably at least 80%, preferably at least 90%, and most preferably at least 100%, faster than the flow rate of the water source through the resin bed in the second vessel.

In the preferred embodiment of at least three vessels (or at least three banks of vessels), the flow rate of the water source through the resin bed in the second vessel is preferably about twice as fast as the flow rate of the water source through the resin bed in the first vessel, and the flow rate of the water source through the resin bed in the third vessel is preferably about three times as fast as the flow rate of the water source through the resin bed in the first vessel.

The volume of resin bed in the second vessel is at least 5%, preferably at least 10%, and more preferably at least 15%, preferably at least 20%, preferably at least 30%, preferably at least 40%, and most preferably at least 50%, bigger than the volume of resin bed in the first vessel.

In the preferred embodiment of at least three vessels (or at least three banks of vessels), the volume of resin bed in the second vessel is at least 5%, preferably at least 10%, and more preferably at least 15%, preferably at least 20%, preferably at least 30%, preferably at least 40%, and most preferably at least 50%, bigger than the volume of resin bed in the first vessel, and the volume of resin bed in the third vessel is at least 5%, preferably at least 10%, and preferably at least 15%, preferably at least 20%, preferably at least 30%, preferably at least 40%, and most preferably at least 50%, bigger than the volume of resin bed in the second vessel.

In a preferred embodiment, the resin bed is an ion exchange resin, preferably a strong base anion exchange resin (gel or macroporous type), more preferably a styrene-divinylbenzene gel resin in either the chloride form or the mixed chloride, sulfate and bicarbonate form.

In a preferred embodiment, after the pre-determined period of time when the resin beds in all the vessels (or banks of vessels) have been replaced with fresh resin at least once, the specific flow rates of the water source through all the resin beds are substantially the same.

In a preferred embodiment, after the pre-determined period of time when the resin beds in all the vessels (or banks of vessels) have been replaced with fresh resin at least once, the volumes of resin beds in all the vessels (or banks of vessels) are substantially the same.

In a preferred embodiment, the resin beds are replaced with fresh resin after about 12 to 48 months.

In a preferred embodiment, the method is used for removing nitrates from a water source.

In accordance with the present invention, there is also provided a method of removing PFAS from a PFAS-containing water source. The method includes the steps of (a) providing a plurality of vessels, each containing a bed of PFAS ad/ab-sorbing material, each vessel having an inlet and an outlet; (b) introducing a PFAS-containing water source into the inlet of a first vessel at a first specific flowrate for a first period; (c) introducing a PFAS-containing water source into the inlet of a second vessel at a second specific flowrate for a second period; (d) optionally introducing a PFAS-containing water source into the inlet of a third vessel at a third specific flow rate for a third period; (e) collecting water at the outlet of each vessel having a lower concentration of PFAS than the water introduced to said vessel; (f) at the end of the first period, replacing the PFAS ad/ab-sorbing material of the first vessel and then resuming introduction of the PFAS-containing water source into the first vessel at a fourth specific flowrate; (g) at the end of the second period, replacing the PFAS ad/ab-sorbing material of the second vessel and then resuming introduction of the PFAS-containing water source into the second vessel at said fourth specific flowrate; (h) optionally at the end of the third period, replacing the PFAS ad/ab-sorbing material of the third vessel and then resuming introduction of the PFAS-containing water source into the third vessel at said fourth specific flowrate; and (i) collecting water at the outlet of each vessel having a lower concentration of PFAS than the water introduced to said vessel.

### BRIEF DESCRIPTION OF THE FIGURES

FIG. 1 is a graph showing a typical ‘breakthrough’ for PFOA using a single ion exchange vessel, beginning with fresh resin and ending with exhausted resin.

FIG. 2 shows a typical ‘LEAD-LAG’ vessel design and operation for PFAS-selective resin.

FIG. 3 shows multiple pairs of ion exchange vessels operated in ‘LEAD-LAG’ mode.

FIG. 4 is a graph showing improved operating efficiency with ‘LEAD-LAG’ operation.

FIG. 5 is a graph showing typical interval of hours for staggered start nitrate removal.

FIG. 6 shows a simple schematic representation of an example of the present invention, which includes multi-bank filtration with all vessels operating in parallel.

FIG. 7 is a graph showing an example of the multi-bank filtration method using progressive loading during Cycles 1 and 2.

FIG. 8 is a graph showing an example of the multi-bank filtration method in operation, transitioning from progressive mode to staggered mode.

### DETAILED DESCRIPTION OF THE INVENTION

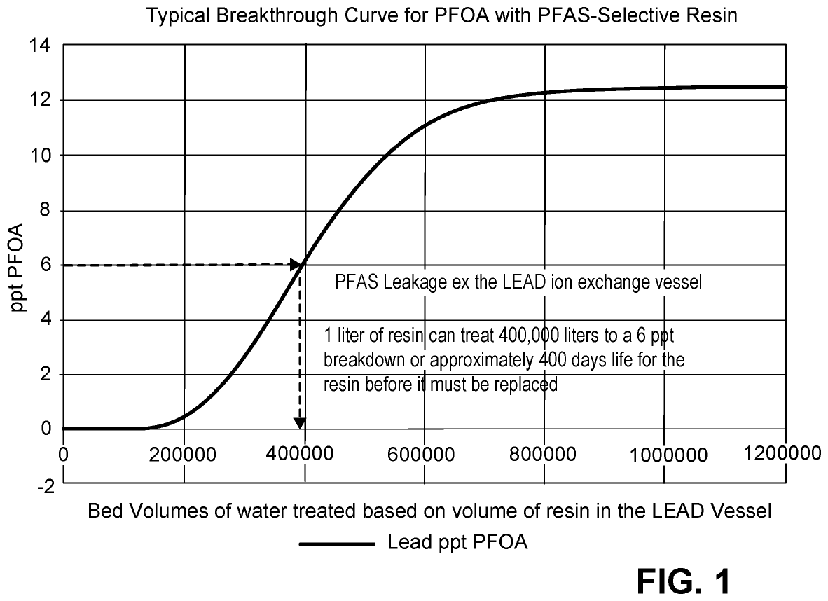

Referring to FIG. 1, there is shown a ‘breakthrough’ curve for treating PFAS such as PFOA using a single ion exchange vessel, with the concentration of PFOA in parts per trillion shown on the y-axis, while the x-axis shows the volume of water treated by the LEAD vessel in Bed Volumes (a Bed Volume is the volume of water equal to the volume of resin used in the vessel). The incoming untreated water has a PFOA concentration of 13 ppt. As more water is treated, some of the PFOA leaks out from the resin column with leakage increasing as more water is treated. The example shows that about 400,000 liters of water can be treated by 1 liter of resin to a 6 ppt breakpoint before the resin must be replaced—roughly after about 400 days of operation in this case.

### ‘LEAD-LAG’ Systems

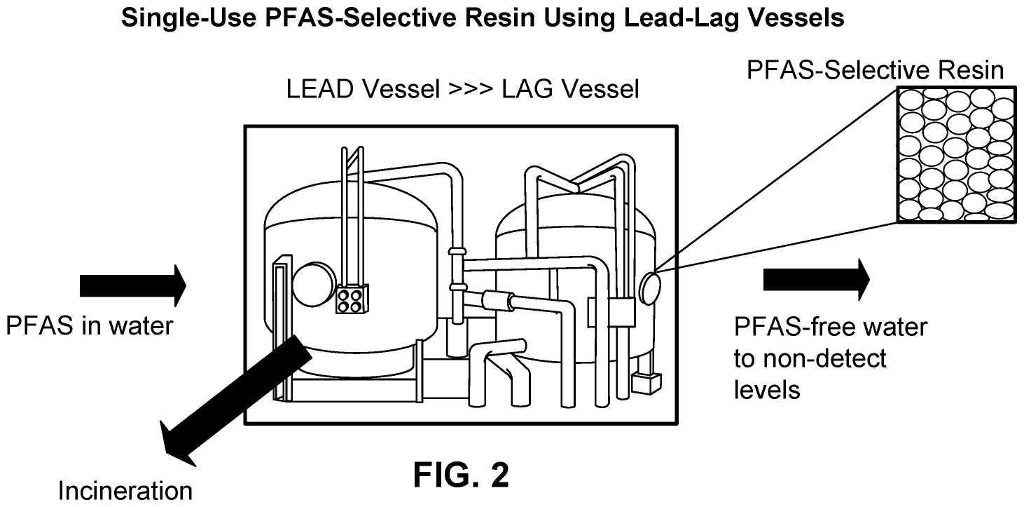

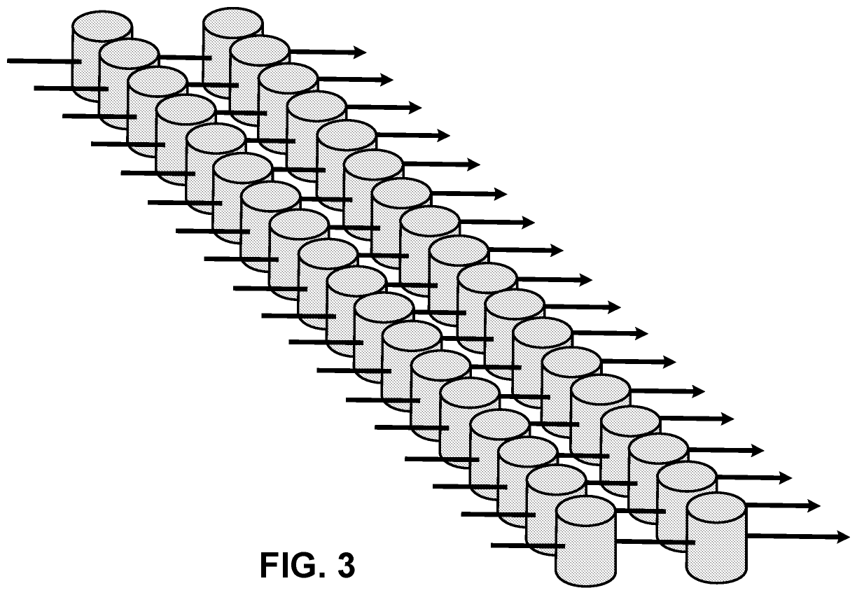

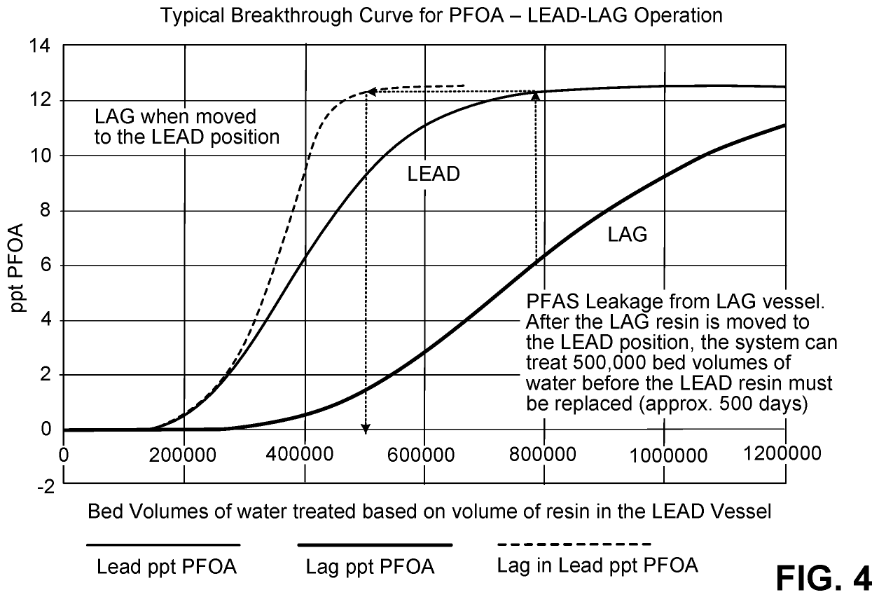

Commercial systems for PFAS removal use the conventional ‘LEAD-LAG’ system design in which pairs of ion exchange vessels are placed in series to improve removal efficiency and safety of the treated water (see FIG. 2). For very large water treatment plants, multiple ‘LEAD-LAG’ pairs of vessels will be ganged together, such as shown in FIG. 3. On start-up, all PFOA is generally removed by the resin in the LEAD vessel (i.e. the first vessel), and usually little or no PFAS is present in the effluent from either vessel. FIG. 4 is a graph showing typical operating capacity for such a ‘LEAD-LAG’ system. Eventually, the capacity of the resin in the lead vessel becomes increasingly exhausted, leading to increasing traces of PFAS in the water leaving the LEAD vessel. This trace amount of PFAS leaving the LEAD vessel, i.e. PFAS leakage from the LEAD vessel, is then captured by the resin in the LAG vessel—essentially polishing the concentration of the PFAS to very low and even undetectable levels. However, eventually, the capacity of the LAG resin also becomes increasingly exhausted and some leakage of PFAS occurs in the effluent water from the LAG vessel. Meanwhile, the concentration of the PFAS in the effluent from the LEAD vessel continues to increase. The increasing leakage is an indication that the resin in the lead position is nearing exhaustion and is thus being loaded to its optimum point while relying on the resin in the LAG vessel to polish and complete the treatment. Using a LAG vessel therefore allows for a higher loading of PFAS and a longer run of the resin in the LEAD vessel, thus increasing operating efficiency, reducing the frequency of replacement of resin in the LEAD vessel, and reducing operating costs for the plant.

In the example shown in FIG. 4, the system is operated until the effluent from the LAG vessel reaches 6 parts per trillion (ppt) PFOA. This is an arbitrary value chosen to ensure the PFOA level in the treated water is significantly lower than whatever is considered a tolerable level. At that point, the resin in the LEAD vessel is replaced with fresh resin. Before the start of the next treatment cycle, it is normal practice with ‘LEAD-LAG’ operation to switch the LEAD vessel with the LAG vessel by adjusting the interconnecting valves. This assures that the water leaving the system is last in contact with the freshest resin to get the greatest extent of contaminant removal. This means that the vessel in the LEAD position at start-up of the next treatment cycle is already partially exhausted with PFOA picked up during the previous cycle. Because of this, the partially exhausted resin exhibits reduced operating capacity to reach the same breakpoint concentration. This is shown by the dashed line in the graph of FIG. 4. The reduced capacity of the LEAD vessel has a corresponding impact on the capacity shown by the resin in the LAG vessel. This reduction in operating capacity will be experienced with every charge of resin that is subsequently moved from the LAG position to the LEAD position (assuming all other things are equal from cycle to cycle). Despite this reduction in operating capacity, the capacity obtained is still significantly higher compared to what would be obtained if only the LEAD vessel was operated. This example shows a steady-state operating capacity of the ‘LEAD-LAG’ system of 500,000-bed volumes versus the 400,000-bed volumes operating capacity for use of the lead vessel of resin alone. This represents a 20 percent reduction in resin operating cost and is typical of what is obtained when using a ‘LEAD-LAG’ system.

### Staggered Operation

Staggered operation of ion exchange resin vessels is a technique typically used for removal of nitrate, hardness, arsenic, and similar contaminants from water. The technique does not typically use ‘LEAD-LAG’ series of vessels as a way to get lower contaminant leakage, but relies instead on operating several vessels in parallel and staggering the operation of these vessels in order to get lower leakage. Resin operating life for nitrate and similar contaminants are typically short, ranging from several hours to a few days; after this time the resin is usually regenerated with a brine or chemical solution and then returned to service. In contrast, the service life of highly PFAS-selective resins used for removal of PFAS is typically measured in months to years before the resin is replaced and disposed of. Staggered operation allows for some vessels to be in their freshest state at the beginning of their service phase, while other vessels are in the middle of their service, and still others will be close to the end of their service. Lastly, other vessels will either be in regeneration or standby mode. In such an operation, the freshest resin with the lowest contaminant loading will produce the best quality of water, resin at the middle of service will produce intermediate water quality, and resin toward the tail end of service will have higher contaminant loading and will produce water of lower quality. The important goal here is to maximize the capacity utilization of all resin charges while blending the water output from all vessels to produce superior steady-state and predictable water quality.

Using the staggered operation approach for nitrate is particularly attractive as the cycle times are relatively short, at about 12 hours, before the resin must be regenerated and returned to service. A common brining system is typically used, allowing for the regeneration of one ion exchange vessel while the others are in service. Once regeneration is complete, the regenerated vessel can be put on standby or put into service when one of the in-service vessels is taken offline for regeneration. For example, if a nitrate treatment system is designed with three ion exchange resin vessels in simultaneous and parallel service and one on standby, then each vessel in service is designed to treat ⅓^{rd} of the influent water flow rate. If each vessel operates for 12 hours before the nitrate leakage reaches a target level in the effluent water, it is taken offline, regenerated, and then put on standby in preparation for returning to service; and, at the same time, the standby vessel is put into service to keep the plant production constant.

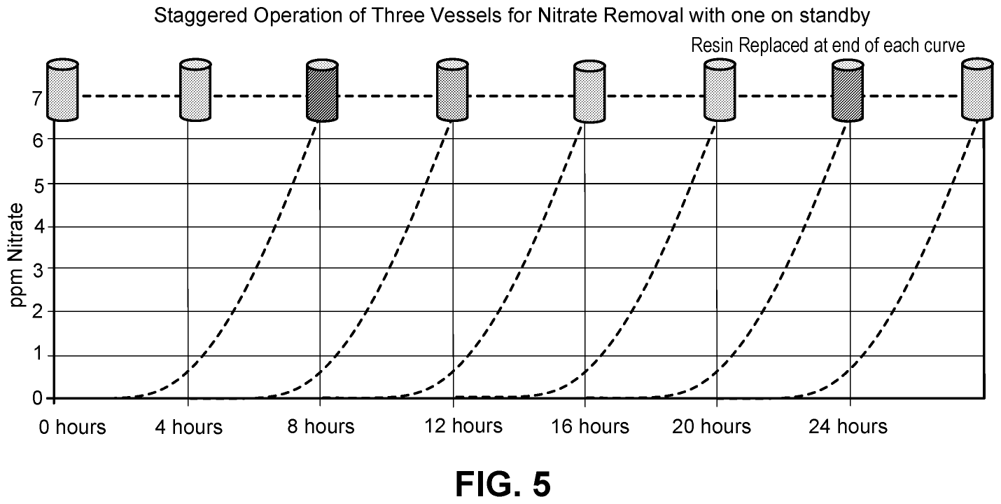

With the staggered vessel technique, each vessel will start-up at a separate time slot compared to the others. For example, the first vessel would start-up at time zero while treating ⅓^{rd} of the full flow rate, the second would start at 4 hours while treating ⅓^{rd} of the full flow rate, and the third would start at 8 hours, resulting in all the influent water being treated. After 12 hours, the first vessel will become exhausted and be taken offline for regeneration; and, at the same time, the standby vessel will be put into service to replace it. This would assure the vessels are spaced 12 hours apart from one another. A key point is that until all three vessels are fully in service, only ⅓^{rd} of the influent water flowrate is treated in the first 4 hours by the first vessel that is put into service, then ⅔^{rd} of the water is treated in the next 4 hours after the second vessel goes into service, and finally, all of the flowrates can then be treated when all three vessels are put online. The sequence for the three operating vessels is depicted in FIG. 5, with the vessels initially put into service in a staggered manner; with one additional vessel, initially on standby, put into service when another one becomes exhausted and is taken offline for regeneration.

An essential feature of staggered vessel operation is the need to have at least one stand-by vessel available with fresh or freshly-regenerated resin, ready to be switched into service when one of the in-service vessels comes offline for regeneration. Otherwise, the plant will continue to produce water but at a reduced rate when one vessel is offline. A very significant advantage of the staggered approach is that the average leakage of the contaminant (in this case, nitrate) at any instant in operation is the blended output from all vessels in operation and is based on the arithmetic average of the leakage values from all vessels in service. With such operation, it is, therefore, possible to achieve overall leakage values that are desirably lower than what can be achieved if all vessels were started up at the same time. For example, from FIG. 5, when all three vessels are in operation 8 hours after start-up, the average leakage of nitrate of the blended effluent water would be approximately 2.3 ppm as nitrate. If all vessels were started up at the same time, the leakage would vary as high as 6.5 ppm as nitrate toward the end of the operating cycle, resulting in less efficient operation.

### Progressive Multi-Bank Filtration

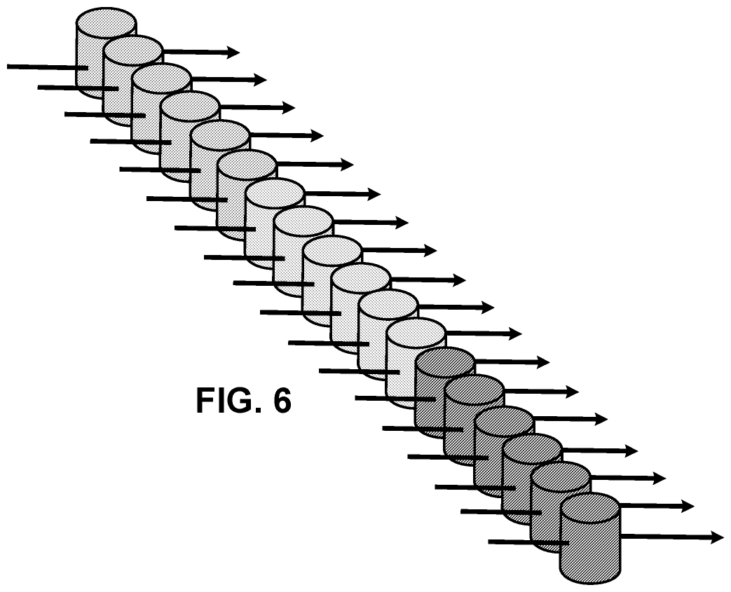

The present invention employs what we have decided to call ‘progressive multi-bank filtration’ (referred to as ‘MBF’ for convenience). Compared to the ‘LEAD-LAG’ design, this approach employs no LAG vessels, reducing the number of vessels needed by half. All ion exchange vessels operate in parallel and the vessels are preferably divided into groupings or resin banks. There are no mandatory spare or standby vessels needed, as the selective resin is preferably used once and then disposed of FIG. 6 is a schematic view of this concept, with vessels divided into three arbitrary groups for ease of understanding, although division into many more banks is possible. Each bank may include any number of vessels, such as the five vessels shown, or just one since the concept is the same. The purpose of dividing the vessels into various groups is to eventually operate each vessel or each bank of vessels in a staggered mode relative to others, with each bank of vessels becoming exhausted at a different time relative to the other banks. Staggered operation results in desirably lower blended leakage values throughout the service cycle. However, when using PFAS-selective resins with relatively long service cycles of, say, 12 to 48 months, it is impractical and highly undesirable to achieve staggered operation by spacing out the start-up of individual vessels over periods of months to years, as users want to treat all the contaminated water from day one, rather than waiting several months or years before the full plant water production can be treated.

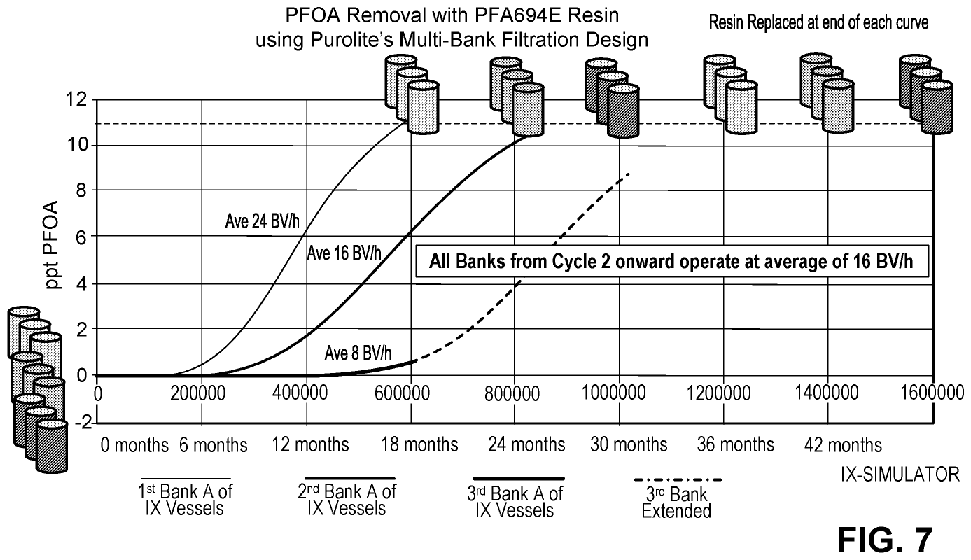

The MBF method resolves the above simultaneous start-up problem by including an essential start-up step, referred to here as ‘a progressive loading step’, which preferably occurs over the first two replacement cycles for the single-use resin. MBF uses two alternate progressive loading steps for this start-up phase. One alternative is to operate the individual banks of resins so they become progressively loaded with PFAS at varied rates from one another, such that some are loaded with low levels of PFAS, some are loaded with intermediate levels of PFAS and some are loaded with high levels of PFAS. The unique approach used in the MBF method is to first divide the resin vessels into specific resin banks, then decide which banks are to be loaded with, for example, low, intermediate, and high levels of PFAS as the water is treated. Once this is decided, then at plant start-up, using one alternative, the specific flowrates through each bank are set at ratios corresponding to the desired PFAS loading targets to be achieved. While the vessels can be divided into any number of multiple banks (and more banks will result in more stable water quality), an example of three banks is chosen to illustrate the concept in FIGS. 6 and 7.

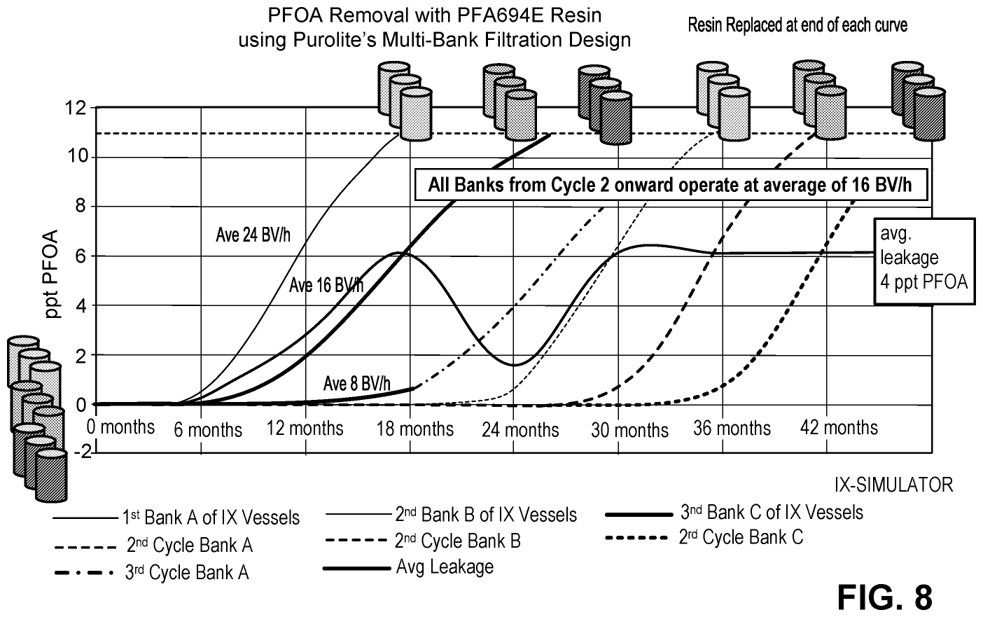

Referring to FIG. 7, in the example given, the cycle time chosen for the single-use resin is 18 months (cycle times can usually vary between 12 to 48 months; 18 months is merely convenient for illustration purposes only) and three banks of resin vessels are shown. All banks are put online at the same time at start-up, at varied flowrates calculated in advance to accommodate plant production needs and to obtain the correct PFAS loading ratios on the respective banks as they continue to treat water. The example shows that the first bank is targeted for the highest PFAS loading (at 24-bed volumes per hour (BV/h)), while the second bank is targeted for intermediate loading (at 16 BV/h) and the third bank for the lowest loading (at 8 BV/h). As water is treated at the indicated flow rates, the loading on each bank will continue to increase in the same ratio as previously set based on the respective flowrates, which, in this case, the PFAS loading for the third bank (set at a specific flowrate of 8 BV/h) will be ⅓ of that loaded on the first bank (with a specific flowrate of 24 BV/h) and the loading on the second bank (with a specific flowrate of 16 BV/h) will be ⅔ of that for the first bank which is set at a flowrate of 24 BV/h. After 18 months of operation (all things being equal), the first bank would have reached its total PFAS target loading, while the second and third will be at ⅔ and ⅓ of their target loadings respectively. The leakage of PFOA from each bank is shown by the leakage curves. After 18 months, the average leakage of the blended water from the three banks will be approximately 6 ppt (the target chosen for this example). The resin in the first bank of vessels would then be changed out and replaced by fresh resin. This example assumes a PFOA concentration in the untreated water at 11 ppt. After the replacement of the resin in the first bank, all specific flowrates in the first, second, and third banks would be adjusted to the same value. In this case, it can be set to the average specific flowrate of 16 BV/h, but could also be set at any higher or lower value that can be accommodated by the plant design, including operation at the peak design rate. From this point onward, all resin vessels will experience equal PFAS loading at equal flowrates and will have the desired spacing of PFAS loading needed to transition to a true staggered mode of operation. The dashed lines in FIG. 8 represent the PFOA leakage expected from the first, second, and third banks respectively. After 24 months have elapsed (from the start), the second bank will reach its target loading and the resin will be replaced. Similarly, after 30 months, the resin in the third bank will be replaced. The system will continue to operate in this way as a truly staggered operation as intended. The instantaneous PFOA leakage in the blended output water from all three banks can be easily calculated from the average values shown at each specific point in the cycle. Even though the target used here was 6 ppt PFOA, it can easily be changed by resetting the final leakage target for each bank at whatever is desired, based on the influent water chemistry and the regulatory limit to be complied with.

As indicated above, most municipal water plants operate at a fraction of their peak flowrate for most of the time. If peak operation is needed, either during the progressive start-up or transition period, this can be accommodated, once it is not sustained indefinitely. For the special case where the plant must operate indefinitely at a maximum peak design rate (which is very unusual), one less desirable option is to increase the number of temporary vessels and use them to achieve peak flowrate, so that the permanent vessels can be used to accomplish the progressive PFAS loading desired for all resin banks. The temporary vessels can either be leased or made permanent. Even so, this would still be advantageous versus the permanent use of multiple pairs of ‘LEAD-LAG’ vessels.

In a preferred embodiment, true staggered operation of the plant may be obtained by initially dividing the number of vessels into multiple banks, and progressively filling increasing resin volumes from the first bank, to the second bank, to the third bank, etc, so the volume of resin (measured by the height of resin in each bank) falls within an acceptable engineering range for good design, starting with the first bank being filled with resin to the lowest acceptable resin height (for example, 30 inches), the last bank being filled to the highest acceptable resin height (for example, 60 inches or higher, dependent on the maximum pressure drop permitted across the resin bed), and the intermediate banks being filled with resin at increments ranging from the lowest to the highest acceptable levels. For example, with 3 banks, one bank will be filled to 30 inches resin height, the second to 48 inches resin height, and the last to 60 inches resin height. In another example, using 6 banks, the first bank would be filled with resin to 30 inches, the second to 36 inches, the third to 42 inches, the fourth to 48 inches, the fifth to 54 inches, and the sixth to 60 inches. Operating all banks with different heights of resin at more or less the same flowrate, results in the bank with the lowest fill volume being capable of treating the lowest volume of water before the resin must be replaced, while banks with increasing volumes of resin will be capable of treating increasing volumes of water before their capacity is spent. In this way, the leakage of PFAS in the treated water from the various banks will be highest from the bank with the smallest volume of resin, and the leakage of PFAS will be lowest from the bank with the largest volume of resin. When the effluent from all vessels is blended, the weighted combined average of PFAS leakage will be at predictable steady-state values, ranging between the lowest and highest leakage. Once the resin in a bank has reached its capacity, the resin can be replaced at that time and the fresh resin volume can be adjusted, as desired, to the resin bed depth that would be used for the long term. For example, if the long-term desired resin bed height is 48 inches and the resin bed being replaced is at a height of 30 inches or 60 inches, the volume of fresh resin will be increased or decreased to obtain the desired fill height of 48 inches, and this would then apply for all subsequent replacements of resin for each vessel.

In one embodiment, progressive flowrates may be combined with progressive resin volumes to give even greater flexibility in handling any water demand, whether it be the peak, average or minimum.

In cases where employing progressive flowrates may result in the linear velocity in one or more banks falling below the minimum recommended linear velocity for good engineering design (e.g. 6 gpm/ft² or 15 m/h), then progressive loading on a 24-hour basis can still be achieved by controlling the volumes of water treated daily by the respective banks, so that the same desired ratios of PFAS loading are achieved. Using the example above employing three banks, if the first bank is operated at a linear velocity of 15 gpm/ft² (or 2.44 MGD), the second bank would operate at ⅔rd of that rate or 10 gpm/ft² (1.63 MGD) and the third would ideally need to operate at ⅓rd of the first rate or 5 gpm/ft² (0.81 MGD); however, since 5 gpm/ft² is below the recommended minimum design rate for good engineering practice, this can potentially create a channeling issue in the resin bed that is undesirable. In such a case, it is practical to modify the method to operate the third bank at a higher linear velocity than the minimum acceptable, while operating throughout the day for a shorter time. For example, the third bank can produce the desired daily volume of water by operating for only 12 hours out of 24 hours while operating at twice the calculated linear velocity, in this case, operating at 10 gpm/ft² instead of 5 gpm/ft². In this way, by controlling the relative volumes of water treated by the respective banks, the progressive PFAS loading would still be preserved, albeit in 24-hour increments.

During stoppage of any bank for replacement of the exhausted resin, or for performing vessel maintenance, the water flowrate normally allocated to that bank will be spread among the other banks that are operational. (This is easily accommodated as large municipal water plants are rarely operated at maximum peak demand and the usual diurnal demands at nighttime and daytime and during winter and summertime are significantly lower than peak demand, ranging typically from 33% to 66% of the peak design flowrate).

Operating in a true staggered mode as described above results in some vessels operating at low PFAS loading, while others are operating at intermediate loading and others are close to their exhaustion point. By blending the treated water output from all banks, a steady-state, predictable water quality is obtained. Average PFAS leakage of the blended water quality is thus easier to control, and can be adjusted to a specific target leakage value, dependent on the influent water quality and the desired treatment target.

Reducing the number of vessels by half compared to a ‘LEAD-LAG’ approach translates to about a 50% reduction in power needed for pumping water through two vessels in series, compared to just one. Similarly, vessel maintenance cost is reduced by half. Over a plant life of twenty years or more, these can add up to significant amounts of savings. Reducing the number of vessels by half also translates to lower analytical costs for PFAS, since not having the LAG vessel will usually mean a significant reduction in the number of water samples needed for analyzing and tracking the performance of the plant.

Although the present disclosure is directed to the removal of PFAS from PFAS-containing water, the present invention may also be employed to remove other contaminants from water, using ad/ab-sorbing materials such as ion exchange resins suitable for removing such contaminants.

1. A method for controlling the amount of leakage of per- and polyfluoroalkyl substances (PFAS) or other contaminants from resin beds during a water purification process to no more than a pre-determined amount, comprising the steps of:
a. providing at least two vessels (or at least two banks of vessels) for water purification, including a first vessel (or first bank of vessels) and a second vessel (or second bank of vessels); each vessel including a resin bed; and
b. starting the water purification process by passing a water source containing PFAS or other contaminants simultaneously and in parallel through the at least two vessels (or at least two banks of vessels);
wherein
for a pre-determined period of time, the specific flow rates for passing the water source through the resin beds in the at least two vessels (or the at least two banks of vessels) differ by at least 5%, preferably by at least 10%, more preferably at least 15%; and
for a pre-determined period of time, the volumes of the resin beds in the at least two vessels (or the at least two banks of vessels) differ by at least 5%, preferably at least 10%, more preferably at least 15%; and
wherein the amount of leakage of per- and polyfluoroalkyl substances (PFAS) or other contaminants is the combined weighted average of leakage from the resin beds in the at least two vessels (or the at least two banks of vessels).

2. The method as claimed in claim 1, wherein the pre-determined period of time runs until at least the resin bed in the first vessel (or first bank of vessels) has been replaced with fresh resin.

3. The method as claimed in claim 1, wherein the specific flow rate of the water source through the resin bed in the second vessel is at least 20%, preferably at least 30%, preferably at least 40%, preferably at least 50%, preferably at least 60%, preferably at least 70%, preferably at least 80%, preferably at least 90%, and most preferably at least 100%, faster than the specific flow rate of the water source through the resin bed in the first vessel.

4. The method as claimed in claim 1, wherein the specific flow rate of the water source through the resin bed in the second vessel is about twice as fast as the specific flow rate of the water source through the resin bed in the first vessel.

5. The method as claimed in claim 1, wherein the volume of resin bed in the second vessel is at least 5%, preferably at least 10%, preferably at least 15%, preferably at least 20%, preferably at least 30%, preferably at least 40%, and most preferably at least 50%, bigger than the volume of resin bed in the first vessel.

6. The method as claimed in claim 1, wherein the resin bed includes PFAS ad/ab-sorbing material.

7. The method as claimed in claim 1, wherein the resin bed is an ion exchange resin.

8. The method as claimed in claim 1, wherein after the pre-determined period of time when the resin beds in the at least two vessels (or at least two banks of vessels) have been replaced at least once, the specific flow rates of the water source through the resin beds is substantially the same.

9. The method as claimed in claim 1, wherein after the pre-determined period of time when the resin beds in the at least two vessels (or at least two banks of vessels) have been replaced at least once, the volumes of the resin beds are substantially the same.

10. The method as claimed in claim 1, wherein the method includes at least three vessels (or three banks of vessels), including in any order: a first vessel (or first bank of vessels), a second vessel (or second bank of vessels), and a third vessel (or third bank of vessels).

11. The method as claimed in claim 10, wherein the specific flow rate of the water source through the resin bed in the second vessel (or second banks of vessels) is at least 20%, preferably at least 30%, preferably at least 40%, preferably at least 50%, preferably at least 60%, preferably at least 70%, preferably at least 80%, preferably at least 90%, and most preferably at least 100%, faster than the specific flow rate of the water source through the resin bed in the first vessel (or first banks of vessels); and the specific flow rate of the water source through the resin bed in the third vessel (or third bank of vessels) is at least 20%, preferably at least 30%, preferably at least 40%, preferably at least 50%, preferably at least 60%, preferably at least 70%, preferably at least 80%, preferably at least 90%, and most preferably at least 100%, faster than the specific flow rate of the water source through the resin bed in the second vessel (or second bank of vessels).

12. The method as claimed in claim 10, wherein the specific flow rate of the water source through the resin bed in the second vessel (or second bank of vessels) is about twice as fast as the specific flow rate of the water source through the resin bed in the first vessel (or first bank of vessels), and the specific flow rate of the water source through the resin bed in the third vessel (or third bank of vessels) is about three times as fast as the specific flow rate of the water source through the resin bed in the first vessel (or first bank of vessels).

13. The method as claimed in claim 1, wherein the resin beds are replaced with fresh resin after about 12 to 48 months.

14. The method as claimed in claim 1, wherein the contaminants include nitrates.

15. The method as claimed in claim 1, wherein the resin beds include strong base anion exchange resins, preferably styrene-divinylbenzene gel resins in either the chloride form or the mixed chloride, sulfate and bicarbonate form.

16. The method as claimed in claim 1, wherein the vessels are of similar size or volume.

17. The method as claimed in claim 1, wherein the size or volume of the vessels differ by no more than 10%, preferably by no more than 5%.

18. The method as claimed in claim 1, wherein the specific flow rates are measured in bed volumes per hour (BV/h).

19. A method of removing per- and polyfluoroalkyl substances (PFAS) from a PFAS-containing water source, comprising:
a. providing a plurality of vessels, each containing a bed of PFAS ad/ab-sorbing material, each vessel having an inlet and an outlet;
b. introducing the PFAS-containing water source into the inlet of a first vessel at a first specific flowrate for a first period;
c. introducing the PFAS-containing water source into the inlet of a second vessel at a second specific flowrate for a second period;
d. optionally introducing the PFAS-containing water source into the inlet of a third vessel at a third specific flowrate for a third period;
e. collecting water at the outlet of each vessel having a lower concentration of PFAS than the water introduced to said vessel;
f. at the end of the first period, replacing the PFAS ad/ab-sorbing material of the first vessel and then resuming introduction of the PFAS-containing water source into the first vessel at a fourth specific flowrate;
g. at the end of the second period, replacing the PFAS ad/ab-sorbing material of the second vessel and then resuming introduction of the PFAS-containing water source into the second vessel at said fourth specific flowrate;
h. optionally at the end of the third period, replacing the PFAS ad/ab-sorbing material of the third vessel and then resuming introduction of the PFAS-containing water source into the third vessel at said fourth specific flowrate; and
i. collecting water at the outlet of each vessel having a lower concentration of PFAS than the water introduced to said vessel.

20. A method of removing per- and polyfluoroalkyl substances (PFAS) from a PFAS-containing water source, comprising:
a. providing a plurality of vessels, each containing a bed of PFAS ad/ab-sorbing material, each vessel having an inlet and an outlet;
b. introducing the PFAS-containing water source into the inlet of a first vessel at a first specific flowrate for a first period;
c. introducing the PFAS-containing water source into the inlet of a second vessel at a second specific flowrate for a second period;
d. collecting water at the outlet of each vessel having a lower concentration of PFAS than the water introduced to said vessel;
e. at the end of the first period, replacing the PFAS ad/ab-sorbing material of the first vessel and then resuming introduction of the PFAS-containing water source into the first vessel at a third specific flowrate;
f at the end of the second period, replacing the PFAS ad/ab-sorbing material of the second vessel and then resuming introduction of the PFAS-containing water source into the second vessel at said third specific flowrate; and
g. collecting water at the outlet of each vessel having a lower concentration of PFAS than the water introduced to said vessel.

21. (canceled)

22. (canceled)

23. The method of claim 19, wherein the inlets and/or the outlets of said plurality of vessels are in parallel fluid communication.

24. The method of claim 19, wherein the PFAS ad/ab-sorbing material is an ion exchange resin.

25. The method of claim 19, wherein each of the first, second and third flowrates differ from each other.

26. The method of claim 19, wherein each of the first, second and third periods are of different lengths.

27. The method of claim 19, wherein each period corresponds to the saturation point of the PFAS ad/ab-sorbing material in said vessel.

28. The method as claimed in claim 1, wherein the pre-determined period of time runs until all of the resin beds have been replaced with fresh resin at least once.
